(19) United States
(12) Patent Application Publication
(10) Pub. No.: US 2024/0140044 A1
(43) Pub. Date: May 2, 2024

(54) ULTRASONIC PROCESSING DEVICES WITH SUPPORT ELEMENT

(71) Applicant: Herrmann Ultraschalltechnik GmbH & Co. KG, Karlsbad (DE)

(72) Inventor: Ulrich Vogler, Uhldingen-Muhlhofen (DE)

(21) Appl. No.: 18/279,926

(22) PCT Filed: May 17, 2022
(86) PCT No.: PCT/EP2022/063238

§ 371 Date: Sep. 1, 2023

(30) Foreign Application Priority Data
May 31, 2021 (DE) 10 2021 113 987.2

(51) Int. Cl. B29C 65/08; B23K 20/10

(52) U.S. Cl. CPC B29C 65/087; B23K 20/103

(57) ABSTRACT

A device for ultrasonic processing of materials comprising a sonotrode rotatable about a first axis and having a first sealing surface extending in the axial direction, the device having a first radial bearing supporting the sonotrode, at least a portion of the first sealing surface being spaced in the axial direction from the radial bearing, characterised in that at least one support element is engageable or in engagement with the sonotrode such that a force acting perpendicular to the axis on an engagement portion of the sealing surface is at least partially taken up by the support element.

The present invention relates to a device for ultrasonic processing of materials comprising a sonotrode rotatable about a first axis and having a first sealing surface extending in the axial direction, the device having a first radial bearing which supports the sonotrode, wherein at least a portion of the first sealing surface is spaced from the radial bearing in the axial direction.

Especially in packaging technology, the ultrasonic processing of materials, and in particular of material webs, is becoming increasingly important.

For example, a device for continuously joining and/or consolidating material webs by means of ultrasound is known from EP 1 514 670 A2, in which a sonotrode in the form of a rotating roller is arranged on a radially opposite counter-tool, wherein material webs are guided through between the sonotrode and the counter-tool for continuous consolidation and/or joining. The sonotrode is excited with an ultrasonic vibration using an ultrasonic converter that is axially attached through an amplitude transformation piece. The ultrasonic converter, which usually has respective piezo elements, converts an electrical alternating voltage into a mechanical vibration. The ultrasonic vibration unit has a sonotrode, an amplitude transformation piece and a converter. These components are adjusted in such a way that when the ultrasonic converter is supplied with an alternating voltage with the natural frequency of the sonotrode, a resonance vibration of the ultrasonic vibration unit is excited.

If, for example, two material webs are simultaneously moved through between the sonotrode and the counter tool and the sonotrode is pressed onto the counter tool with a predetermined force, the ultrasonic vibration is transmitted to the material webs and local heating and possibly welding of the material webs occurs in the region of the interface between the material webs.

Ultrasonic processing ensures that energy is essentially only introduced into the region that needs to be heated for the joint or welding. Consequently, ultrasonic processing can be used for very energy-saving material processing.

For rotating sonotrodes, bearing the sonotrode via radial bearings is common. These can be arranged, for example, between the amplitude transformation piece described above and the rotating sonotrode. Since the first sealing surface is at least in sections axially spaced from the radial bearing and the sonotrode always has a certain elasticity, ultrasonic processing, i.e. bringing the sealing surface into contact with the materials to be processed, always leads to bending of the sonotrode. Such a system corresponds to a one-sided lever with the consequence that on the one hand the radial bearing has to take up high forces and on the other hand the sonotrode bends.

Therefore, two radial bearings are often provided so that the sonotrode is located between the two radial bearings. Such a system corresponds to a bending beam. Providing a second radial bearing reduces the described problems, but does not eliminate them. Even in this case, the sonotrode bends slightly in the region between the radial bearings depending on the force applied to the sealing surface.

In the aforementioned EP 1 514 670 A2, it has therefore already been proposed to thicken the diameter in sections of the sonotrode, which is designed as a rotating roller. For example, it has been proposed to equip the rotating roller with a bombage. The surface of the sonotrode is thus initially slightly bulbous, the shape being calculated such that when the intended welding force is applied, the sonotrode is deformed so that the circumferential surfaces are exactly cylindrical.

However, the change in diameter of the roller is only possible for a specific application. For other applications, the diameter design of the sonotrode must be selected differently, so that each sonotrode can only be used for a specific application.

In addition, especially when wide material webs are to be ultrasonically processed and therefore the distance between the first sealing surface and the radial bearing is inevitably relatively large, the radial bearings must take up very high forces, which leads to high wear of the radial bearings and also places high demands on the quality of the radial bearings. Despite the high quality of the radial bearings, however, there is inevitably a bending of the first sealing surface and thus an uneven welding result.

Based on the described prior art, it is therefore the object of the present invention to provide a device of the type mentioned above, in which the problems described are at least reduced.

According to the invention, this object is solved by providing at least one support element which is engageable or in engagement with the sonotrode in such a way that a force acting perpendicular to the axis on an engagement section of the sealing surface is at least partially taken up by the support element.

This relieves the radial bearing, increases its service life and makes the welding result more uniform. For example, the support element may be arranged to engage the sonotrode at a point opposite the point of expected force transmission during processing. The support element is arranged such that when a force is applied to the sonotrode during material processing, the sonotrode is pressed against the support element.

In the case of a roller-shaped sonotrode, the support element engages the sealing surface, but at a point opposite the portion of the sealing surface that is currently engaging the material.

Therefore, in a preferred embodiment, the support element is spaced from the radial bearing in the axial direction.

In a further preferred embodiment, the support element may be designed as a roller which is rotatable about a second axis which is arranged parallel to the first axis. By designing the support element as a roller, the friction that otherwise exists between the rotating sonotrode and the support element is reduced, since the support element can now roll on the sonotrode. Furthermore, it is advantageous if the roller has a circumferential surface that is curved in the axial direction, preferably the radius of curvature of the axial curvature is at least 10 mm.

In another preferred embodiment, the device has a second radial bearing supporting the sonotrode, wherein the engagement portion of the sealing surface is arranged in the axial direction between the first and second radial bearings. By providing a second radial bearing, the first radial bearing can be relieved.

In a further preferred embodiment, it is provided that the sonotrode has a cylindrical portion with a circumferential surface, wherein the circumferential surface forms the sealing surface and the support element is in contact with the sealing surface. In this embodiment, at least during material processing, both the material and the support element are in contact with the sealing surface, whereby the force exerted by the material on the sealing surface pushes the sonotrode in the direction of the support element.

Furthermore, in a preferred embodiment, it is possible that a counter tool with a second sealing surface is provided, which is arranged in such a way that a slit remains between the first and the second sealing surface, through which the materials to be processed can be advanced. Even though ultrasonic processing is possible without a counter tool, it has been shown that by providing a counter tool, the processing quality can be maintained at a consistently high level.

In this regard, the counter-tool can be rotatable about a third axis arranged parallel to the first axis, the counter-tool preferably having a cylindrical portion with a circumferential surface, the circumferential surface of the cylindrical portion of the counter-tool forming the second sealing surface. In this case, the circumferential speed of the sonotrode and the circumferential speed of the counter tool can be the same and correspond to the material feed speed at which the material to be processed is guided through the slit.

In a further preferred embodiment, it is provided that the sonotrode is adapted for being excited into resonant vibration with an ultrasonic acoustic vibration of the wavelength λ, wherein at least two support elements are provided which are preferably spaced apart from each other in the axial direction, preferably with a spacing of λ/2 or a multiple thereof.

By this measure, the support element can be positioned at a position on the sealing surface of the sonotrode at which the vibration amplitude in the axial direction is minimal in order to influence the ultrasonic vibration of the sonotrode as little as possible.

In a further preferred embodiment, the at least one support element is movable relative to the sonotrode in the radial direction, wherein preferably a drive is provided for radial movement of the at least one support element in the radial direction.

The support element can then only be used when necessary, since the support element, if it comes into contact with the sonotrode, can impair the oscillation behaviour of the sonotrode. In addition, the support element is subject to a certain amount of wear, since a small amount of vibration energy is transferred from the sonotrode to the support element. This wear can also be noticeably reduced if the support element only comes into contact with the sonotrode when necessary.

Likewise, the pressure forces of the support rollers can be varied depending on the speed of the material processing, i.e. depending on the material web speed. In order to introduce the necessary welding energy into the material web at a higher material web speed, the force with which the sonotrode is pressed onto the material web can be increased. With the aid of the support rollers, the contact pressure along the first sealing surface can be kept approximately constant.

It can also be advantageous to use servo drives instead of pneumatic cylinders.

Furthermore, it can be advantageous to position force sensors between the drives, such as the pneumatic cylinders and the drive rollers, in order to measure the actual contact pressure at any time and to adjust it if necessary.

Many drives, and especially pneumatic cylinders, have hysteresis properties that can also change during the period of use. Therefore, the pneumatic pressure in the pneumatic cylinder does not always represent the actual contact pressure. By the measurement using force sensors, the contact pressure can be set or even controlled independently of the hysteresis property of the drive.

Further advantages, features and possible applications of the present invention will become apparent from the following description of preferred embodiments and the accompanying figures. They show:

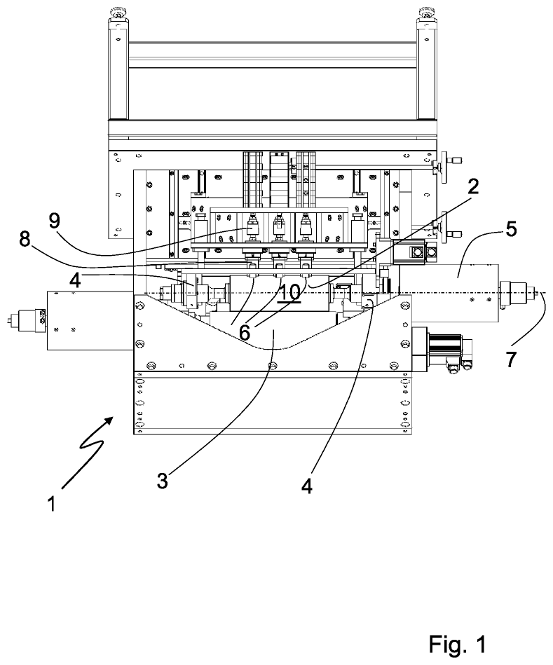

FIG. 1 is a schematic view of an inventive embodiment according to the invention, and

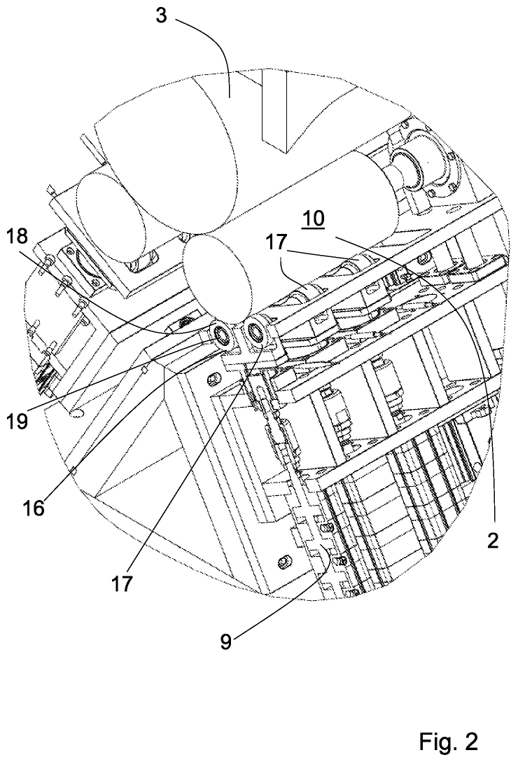

FIG. 2 is a schematic partial sectional view of a second embodiment of the invention.

FIG. 1 shows a side view of a first embodiment of the invention. The ultrasonic processing device 1 comprises a sonotrode 2 having a roller-shaped portion 10 serving as a first sealing surface. The sonotrode 2 is rotatable about the first axis 7.

The sonotrode 2 is held by two radial bearings 4, which are spaced in the axial direction of the roller-shaped section 10. The sonotrode 2 is set into resonant ultrasonic vibration by means of a converter 5. The radial bearings 4 are positioned in such a way that they influence the oscillation behaviour of the sonotrode as little as possible.

A counter tool 3 is arranged next to the sonotrode 2, which in the example shown also has a roller-shaped section. The roller-shaped section of the counter tool 3 forms the second sealing surface. Material webs can be passed between the two sealing surfaces of the counter tool 3 and the sonotrode 2.

Due to the ultrasonic vibration of the sonotrode 2 and the contact between the sonotrode 2 and the material webs to be processed, the ultrasonic vibration is transmitted into the material webs located between the sonotrode 2 and the counter tool 3 and these can for example be welded together.

For ultrasonic processing, however, it is also necessary to exert a not insignificant force on the material with the aid of the sonotrode 2 or with the aid of the counter tool 3. Since the sonotrode 2 is only supported on its two radial bearings 4, this would lead to a bending of the sonotrode 2.

In order to at least reduce this bending, three support elements 6 shown as rollers are provided in the example shown, which are each held in a cassette 8, which can be moved in the direction of the sonotrode 2 or away from it with the aid of a pneumatic cylinder 9.

Whenever, during ultrasonic processing of the material webs, the sonotrode 2 is bent upwards due to the introduction of force into the material in the figure, the support elements 6 engage with the sonotrode 2, roll on the surface of the roller-shaped section 10 of the sonotrode 2 and take up the force so that there is actually no or virtually no bending of the sonotrode 2. This improves the processing quality and relieves the radial bearings.

Basically, with this type of sonotrode, it is desired that the roller-shaped sealing surface performs a radial oscillation with a frequency in the ultrasonic range. In addition, however, a vibration in the axial direction is generated on the surface of the roller-shaped section 10. Here, there are regions that have a relatively large radial amplitude and regions that have a relatively small radial amplitude. The regions with relatively small radial amplitude are spaced apart from each other by half the wavelength of the ultrasonic vibration with which the sonotrode is excited. Therefore, the distance from adjacent support elements 6 in the embodiment shown has been chosen λ/2.

Instead of the regions with relatively small radial amplitude, the regions with minimum total amplitude, which is composed of the axial and the radial amplitude, can also be selected as the position for the support elements. In this case, the distance from adjacent support elements 6 is again λ/2.

FIG. 2 shows an alternative embodiment in which the reference numbers for the same components have been chosen to be the same. Only a partial section view is shown here.

The embodiment shown in FIG. 2 differs from the embodiment shown in FIG. 1 essentially in that six support elements in the form of support rollers 16, 17 are provided. However, in contrast to FIG. 1, the six support elements 16, 17 are not arranged on a line parallel to the first axis. Instead, two groups of support elements 16, 17 are provided, each support roller of one group being arranged on a line parallel to the first axis, while the two groups of support elements 16, 17 are arranged on different lines.

As shown in the schematic cross-sectional view in FIG. 2, the support elements 16, 17 are not arranged exactly opposite to the counter tool 3, i.e. the support elements 16, 17 do not lie on the straight line connecting the centres of the roller-shaped sonotrode 2 and the roller-shaped counter tool. Instead, the two groups of support elements 16, 17 lie on opposite sides of the imaginary straight line through the centres of the sonotrode 2 and the counter tool 3. The support rollers 16, 17 each have a multi-part construction and have a wheel element designated with the reference number 19 and a wear element 18 enclosing the wheel element 19. The wear element 18 is made of PEEK, for example, and can be easily replaced if necessary.

The sonotrode does not have to be cylindrical. It can also have, for example, four bars, each serving as a sealing surface, which perform a welding operation when the sonotrode is rotated one after the other opposite the counter tool. During the welding operation, the opposite sealing surface of the sonotrode, which is not performing a welding operation, is in contact with corresponding support elements which take up the force applied by the counter tool 3.

### REFERENCE NUMERALS

1 ultrasonic processing device
2 sonotrode
3 counter tool
4 radial bearing
5 converter
6 16, 17 support element
7 first axis
8 cassette
9 pneumatic cylinder
10 roller-shaped section

1. Device for the ultrasonic processing of materials,
comprising a sonotrode rotatable about a first axis and having a first sealing surface extending in the axial direction,
the device having a first radial bearing which supports the sonotrode,
wherein at least a portion of the first sealing surface is spaced in the axial direction from the radial bearing,
characterised in that at least one support element is engageable or is in engagement with the sonotrode in such a way that a force acting perpendicularly to the axis on an engagement portion of the sealing surface is at least partially taken up by the support element.

2. The device according to claim 1, characterised in that the support element is spaced apart from the radial bearing in the axial direction.

3. The device according to claim 1,
characterized in that the support element is designed as a roller which is rotatable about a second axis which is arranged parallel to the first axis.

4. The device according to claim 3, characterized in that the roller has a circumferential surface which is curved in the axial direction.

5. The device according to claim 1,
characterized in that the device has a second radial bearing supporting the sonotrode, wherein the engagement portion of the sealing surface is arranged in the axial direction between the first and the second radial bearing.

6. The device according to claim 1,
characterised in that the sonotrode has a cylindrical portion with a circumferential surface,
the circumferential surface forming the sealing surface and the support member being in contact with the sealing surface.

7. The device according to claim 1,
characterized in that a counter tool with a second sealing surface is provided,
which is arranged in such a way that a slit remains between the first and the second sealing surface, through which the materials to be processed can be advanced.

8. The device according to claim 6,
characterized in that the counter-tool is rotatable about a third axis which is arranged parallel to the first axis.

9. The device according to claim 1,
characterized in that the sonotrode is adapted for being excited into resonant vibration with an acoustic ultrasonic vibration of the wavelength λ,
wherein at least two support elements are provided.

10. The device according to claim 1,
characterized in that the at least one support element is movable relative to the sonotrode in the radial direction.

11. The device according to claim 3,
characterized in that the support element has two rollers, the two rollers being rotatable about axes spaced apart from each other.

12. The device according to claim 3, wherein the roller consists of a wheel element and a wear element surrounding the wheel element.

13. The device according to claim 12, wherein the wear element consists of PEEK.

14. The device according to claim 4, wherein the radius of curvature of the axial curvature is at least 10 mm.

15. The device according to claim 8, wherein the counter-tool has a cylindrical portion with a circumferential surface,
wherein the circumferential surface of the cylindrical portion of the counter-tool forms the second sealing surface.

16. The device according to claim 9, wherein adjacent support elements are spaced apart in the axial direction by a distance of λ/2 or a multiple thereof.

17. The device according to claim 10, wherein a drive is provided for radial movement of the at least one support element in the radial direction.
